(19) United States
(12) Patent Application Publication
(10) Pub. No.: US 2010/0120008 A1
(43) Pub. Date: May 13, 2010

(54) SYSTEM AND METHOD FOR INTERACTIVE LEARNING ON TELEVISION

(76) Inventors: Patrick J. McDonagh, Tara (IE); John P. Allen, Carrigaline (IE)

Correspondence Address: MORRISON & FOERSTER LLP, 12531 HIGH BLUFF DRIVE, SUITE 100, SAN DIEGO, CA, 92130-2040, US

(21) Appl. No.: 12/617,384

(22) Filed: Nov. 12, 2009

Related U.S. Application Data
(60) Provisional application No. 61/114,000, filed on Nov. 12, 2008.

(51) Int. Cl. G09B 7/00

(52) U.S. Cl. 434/323

(57) ABSTRACT

A system and method for providing interactive learning applications on a television and managing the learning process is disclosed. The learning management technology utilizes internet, television, and learning management systems to allow a student to interactively access learning content. The functionality of the learning management system may be accessed on a television via a host server. The interactive application further allows parents and teachers to monitor student performance, change the learning content, control workflow, and send messages and reminders to the student. The interactive application further allows restriction of television viewing based on learning results or until an assignment has been completed. The learning content may be copied or downloaded onto a computer readable medium (e.g., a memory stick) from a central location (e.g., a Kiosk). The learning content may then be copied or uploaded to a television set-top box for execution by the television set-top box. The viewer may interact with the learning application via a remote control or other input device (e.g., a keyboard) coupled to the television set-top box.

### RELATED APPLICATIONS

This application claims priority to U.S. Provisional Patent Application Ser. No. 61/114,000, filed on Nov. 12, 2008, the contents of which are incorporated by reference herein.

### FIELD OF THE INVENTION

The present invention relates generally to interactive learning technologies, and more particularly to interactive learning and managing a learning process on a television.

### BACKGROUND OF THE INVENTION

Many students around the world may not have access to educational materials because of the expense involved. For example, educational materials can be provided to students on a CD for use on a Personal Computer (PC), but it may be too expensive to give each student access to a PC. This may be especially true in nonindustrialized or undeveloped regions of the world. Additionally, to improve a student's performance, parents and teachers may want to be able to control and monitor the student's progress at anytime. Therefore, there is a need for systems and methods for providing improved interactive learning.

### SUMMARY OF THE INVENTION

A system and method for providing interactive learning applications on a television and managing the learning process is disclosed. Embodiments of this invention provide a way to utilize Internet and Learning Management Systems (LMS) technologies with television (TV) technologies for a personalized interactive learning experience via a TV.

According to a first embodiment, the LMS utilizes Internet, television, and learning management system technologies to allow a student to interactively access learning content and learning management system functionality on a television via a host server.

According to a second embodiment, the interactive application further allows parents and teachers to monitor student performance, select or change learning content, control workflow, and send messages and reminders to the student. The parents and teachers may also restrict television viewing based on learning results or until the completion of one or more assignments.

According to a third embodiment, learning content may be downloaded onto a computer readable medium (e.g., a memory stick) from a central location (e.g., a Kiosk or PC), and then copied or uploaded onto a television set-top box (STB/TV) for execution by the STB/TV. In this manner, the viewer can interact with the learning application via a remote control device, or other input devices (e.g., a keyboard) coupled to the STB/TV.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates exemplary interactions between an LMS and a STB/TV, and between an LMS and a Kiosk, according to embodiments of the invention.

FIG. 2 is an exemplary flowchart showing a STB/TV distribution of content and workflow, according to an embodiment of the invention.

FIG. 3 is an exemplary flowchart showing a method for using a portable media device for distribution by students, according to an embodiment of the invention.

FIG. 4 is an exemplary flowchart showing a method for using a portable media device for distribution by parents, according to an embodiment of the invention.

### DETAILED DESCRIPTION OF EXEMPLARY EMBODIMENTS

In the following description of exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

As used herein, the terms “application” and “software” include without limitation any sequence of human or machine cognizable steps that are adapted to be processed by a computer. Such may be rendered in any programming language or environment including, without limitation, C/C++, Fortran, COBOL, PASCAL, Perl, Prolog, assembly language, scripting languages, markup languages (e.g., HTML, SGML, XML, VoXML), functional languages (e.g., APL, Erlang, Haskell, Lisp, ML, F# and Scheme), as well as object-oriented environments such as the Common Object Request Broker Architecture (CORBA), Java™ (including J2ME, Java Beans, etc.).

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “module” refers to any combination of software, firmware, or hardware that may be used to perform a designated function. While various modules may be described as discrete modules throughout the specification, one of ordinary skill in the art will appreciate that multiple modules may be combined to form a single module according to various embodiments of the invention.

As used herein, the term “network” refers generally to any type of telecommunications or data network including, without limitation, cable networks, satellite networks, optical networks, cellular networks, and bus networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, hybrid fiber coaxial, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the term “server” includes without limitation any computerized component, system or entity (regardless of form) which is adapted to provide data, files, applications, content, or other services to one or more other devices or entities on a computer network.

As used herein, the term “wireless” refers to any wireless signal, data, communication, or other interface including, without limitation, Wi-Fi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

The present disclosure is directed toward systems and methods for providing interactive learning applications on a television and managing the learning process. Various embodiments of the invention are described herein in the context of one practical application, namely, interactively learning and managing the learning process on TV. In this context, the example system is applicable to provide a way to utilize Internet and LMS technologies with TV technologies for a personalized interactive learning experience for TV. Embodiments of the disclosure, however, are not limited to such applications, and the methods described herein may also be utilized in other applications. As would be apparent to one of ordinary skill in the art after reading this description, these are merely examples, and the invention is not limited to operating in accordance with these examples.

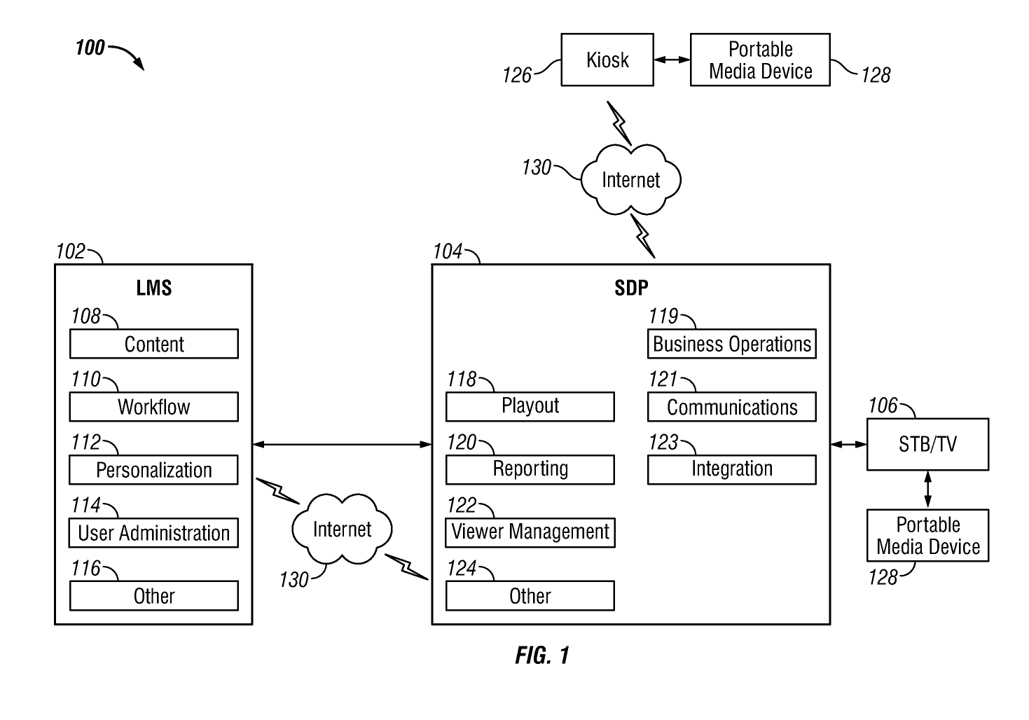

FIG. 1 illustrates exemplary interactions between an LMS and a STB/TV, and between an LMS and a Kiosk, according to embodiments of the invention. Elements involved in the interaction 100 may include an LMS 102, an Interactive TV Service Delivery Platform (SDP) 104, a STB/TV 106, a Kiosk 126, and a portable media device 128.

The LMS 102 is operable to provide access to self-paced learning content for students. The LMS 102 may be implemented as any combination of software, hardware, and firmware. In one embodiment, the LMS 102 may include: a content repository module 108, a workflow management engine 110, a student personalization module 112, a user administration module 114, and other LMS modules 116. In some embodiments, the LMS 102 may be available as a commercial product (e.g., Blackboard, Desire2Learn, etc.), and optionally may include open source software (e.g., ATutor, Claroline, etc.).

An Interactive TV Service Delivery Platform (SDP) 104 may be used to provide functionality which enables television operators to deliver and manage next-generation interactive television services. In some embodiments, the SDP 104 may directly interface with a STB/TV 106 via a cable or wireless connection. In other embodiments, the SDP 104 may be situated remotely relative to the STB/TV 106. For example, the SDP 104 may be integrated within the LMS 102 or exist as a stand-alone server. Additionally, the SDP 104 may interface with the STB/TV 106 via an Internet or cable connection (e.g., over a coaxial cable connected to a cable modem or to the STB/TV 106). Note that the SDP 104 may be implemented as any combination of software, hardware, and firmware. Also, the SDP 104 may include software that is available as a commercial product (e.g., DigiSoft, Quative, NDS, etc.) according to some embodiments.

The SDP 104 may also contain a variety of modules for implementing application specific functionality. For example, in one embodiment, the SDP 104 includes personalization functionality (e.g., viewer management module 122) for enabling a user to personalize his or her display, audio, interface, and/or presentation settings; broadcast functionality (e.g., playout module 118) for presenting output upon one or more associated displays; reporting functionality (e.g., reporting module 120) for reporting the user's activity/inactivity, completed assignments, assignment scores, television viewing histories or other information; business functionality (e.g., business operations module 119) for managing account information and subscription access; communications functionality (e.g., communications module 121) for transmitting data to or receiving data from one or more remote devices; integration functionality (e.g., integration module 123) for integrating user accounts, students, hardware devices, workflows, content and other LMS related entities; as well as various other modules 124. These other modules 124 may include, for example, interfaces to connect to service providers (e.g., phone or cable companies), storage media, power supplies, communication ports for external equipment, output devices (i.e., speakers, displays, printers), etc.

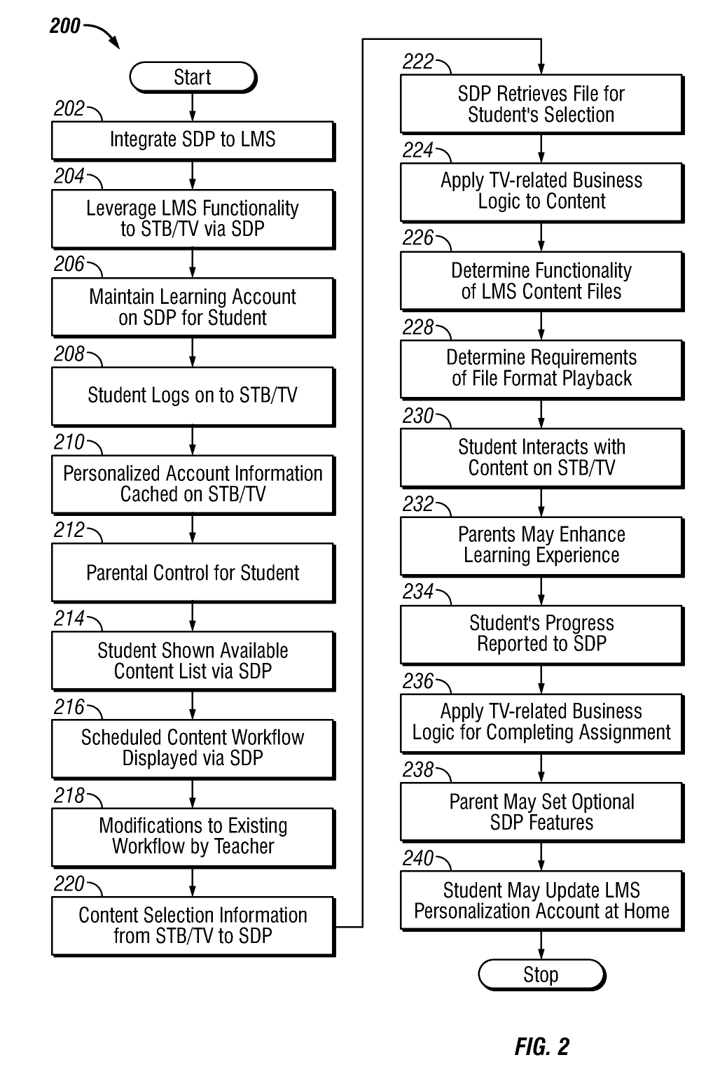

According to some embodiments, the LMS 102 may utilize the Internet 130 to allow a student to interactively access the learning content and functionality of the LMS 102 on the STB/TV 106 via the SDP 104. In this matter, learning materials (e.g., schedules, assignments, etc.) may be sent from LMS 102 to the STB/TV 106, via the SDP 104, for viewing by the students (as explained in more detail in the context of discussion of FIG. 2 below).

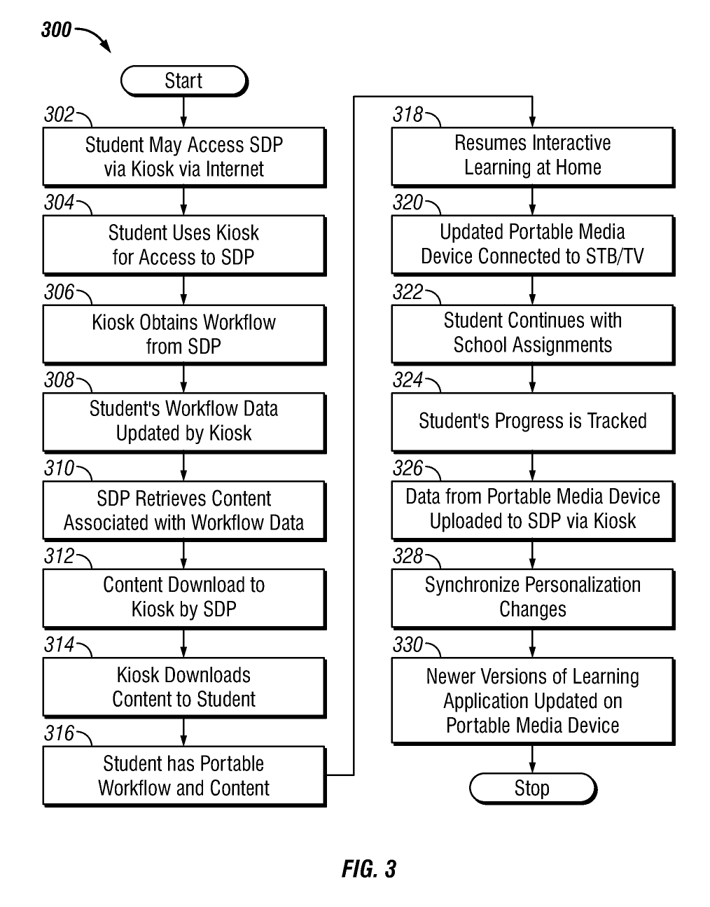

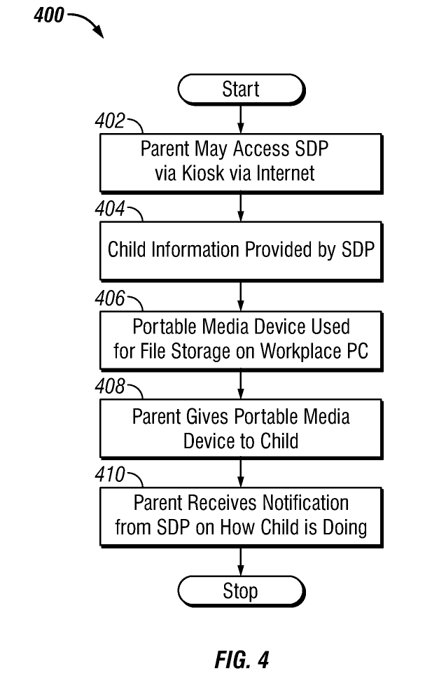

Alternatively, learning content from LMS 102 may be copied or downloaded onto a computer readable medium such as a portable media device 128 (e.g., a memory stick) from a central location such as the Kiosk 126. The learning content may then be copied or uploaded onto the STB/TV 106 for execution by the television STB/TV 106 (as explained in more detail in the context of discussion of FIG. 3 and FIG. 4 below). A viewer (e.g., student, parent) may interact with the learning application and/or contents via an input device coupled to the STB/TV 106 (not shown in FIG. 1). The input device may consist of any device capable of providing input, including, without limitation, a remote control, a keyboard, a mouse, a touch sensor panel, a microphone, etc.

In some embodiments, the SDP 104 may be operable to manage the interaction between the LMS 102 and the STB/TV 106. Also, in some embodiments, the SDP 104 may be operable to manage the interaction between the LMS 102 and the Kiosk 126.

The Kiosk 126 may be implemented as an electronic device, for example, a small, self-standing physical structure containing a computer with a touch-screen display, a shared PC in a computer lab, an individual's notebook computer, etc. The Kiosk 126 may be located in any number of settings, including, for example, the common areas within a school such as a cafeteria, a classroom, a library, etc. Additional access to SDP 104 may be made available outside of the school, as well as outside of the home, through Kiosks placed in areas such as shopping malls, public libraries, government buildings, etc. In some embodiments, one or more Kiosks can be connected to the SDP 104 through the Internet 130.

Although in the embodiments shown in FIG. 1, the LMS 102, the SDP 104, and the Kiosk 126 are shown as separate elements, they may be combined to form various other configurations. For example, in one embodiment, the LMS 102 may be included within the SDP 104. Alternatively, the LMS 102, the Kiosk 126, and the SDP 104 may be combined to form another configuration. In this manner, any combination of the Kiosk 126, the LMS 102, and the SDP 104 may be possible according to various embodiments of the invention.

The STB/TV 106 may include a combination of separate components or may be a single, integrated component. In some embodiments, the STB/TV 106 may comprise standard cable and/or TV components along with SDP and/or LMS components. In other embodiments, the SDP 104 may be connectable to the STB/TV 106 by one or more communication ports (e.g., via a serial bus, coaxial, HDMI cable or over a wireless connection).

FIG. 2 is an exemplary flowchart 200 showing the STB/TV 106 distribution of content 108, and workflow 110, for the student's STB/TV 106 with an Internet 130 connection (FIG. 1), according to an embodiment of the invention. The various tasks performed in connection with process 200 may be performed by software, hardware, firmware, a computer-readable medium having computer executable instructions for performing the process method, or any combination thereof. It should be appreciated that process 200 may include any number of additional or alternative tasks. The tasks shown in FIG. 2 need not be performed in the illustrated order, and these processes may be incorporated into a more comprehensive procedure or process having additional functionality not described in detail herein. For illustrative purposes, the following description of process 200 may refer to elements mentioned above in connection with FIG. 1. Also, in various embodiments, portions of process 200 may be performed by different elements shown in interaction 100, e.g., LMS 102, SDP 104, and STB/TV 106.

In some embodiments, process 200 may begin by integrating a television management platform such as the SDP 104 platform into the LMS 102. In this manner, the television management platform may be used to present the functionality of the LMS 102 on the STB/TV 106 for viewing by a user (e.g., student, parent) (task 202). The SDP 104 can manage the interactions between the LMS 102 and the student's STB/TV 106.

Process 200 may then leverage the functionality of the LMS 102 (task 204) to the STB/TV 106 via the SDP 104. A remote input device, as explained above, can be used on the STB/TV 106 by the student to communicate with the SDP 104.

In some embodiments, process 200 may maintain personalized television learning accounts (e.g., TV student 1 profile) for each student (e.g., TV student 1) via the SDP 104 (task 206). The SDP 104 may leverage the existing LMS personalization 114 (e.g., personal account information, or profile) for TV specific accounts. For example, the LMS personalization 114 may contain a student's personal data (e.g., LMS student 1 profile) such as name, address, grade level, and so on. The SDP 104 may associate the LMS student 1 profile with the TV student 1 profile, such that the LMS student 1 profile becomes the TV student 1 profile. In this manner, the SDP 104 can provide TV students, such as the TV student 1, with personalized TV prompts. These personalized TV prompts can be in a form of a schedule and/or content reminder to the TV student 1. The SDP 104 personalization may be implemented using the viewer management module 122 in conjunction with the SDP's TV notification and broadcast technology of the playout module 118.

STB/TV 106 specific personalization may be managed using SDP account functionality and implemented by an SDP viewer management module 122. A student can use their remote input device to enter new account information data or can select an existing LMS account to associate with via the SDP 104. Alternatively, the accounts may include a default-user setting for each STB/TV 106 when multiple STB/TVs or students are in a home.

Process 200 may then allow students to log on to their STB/TV 106 to access the learning applications (contents) (task 208). For example, the learning application may include lessons, learning programs from the TV learning channels, or other such content. In some embodiments, a student can be associated with one or more STB/TVs. For example, in one embodiment, a machine access code (MAC) of the STB/TVs may be mapped to a student's login information when the student logs in for a first time on a STB/TV 106. In some embodiments, if more than one student is accessing one of the learning applications on the same STB/TV 106, then login information with user name, and password, for each student (account) may be provided. A login screen may be provided to show a list of users who previously logged on from that MAC address of the STB/TV 106, or alternatively to allow a new student to login.

Process 200 may allow personalized account information to be cached within the STB/TV 106 (task 210) or the SDP 104. In this manner, the personalized account information may be saved locally, as opposed to being communicated to one or more remote modules (e.g., the SDP 104 and/or the LMS 102). In some embodiments, this caching method can allow for better performance and possibly a reduction in network traffic. Note that a wide variety of information may be cached in this manner, including, for example, mapping information (e.g., MAC address/student), student input, personalization data, configuration options, etc. In some embodiments, locally cached data may be asynchronously transmitted to one or more remote modules in order to minimize network traffic during peak traffic times.

In some embodiments, process 200 may allow parental control for a student's access (task 212). This may be used, for example, to assist the student in maintaining good study habits or to minimize distractions which prevent the student from completing assignments. In this manner, the SDP 104 can provide features that can help students with their performance and progress.

In one embodiment, a specified time can be set by the parent for the student to begin accessing the learning application's scheduled content. For example, the time of day when a student begins an assignment may be inappropriate if it is too late or there is no parental supervision available. Hence, this set time requirement can allow a parent to control access to the STB/TV 106, and can also provide an assigned schedule for each student. Moreover, a parent may want the student to complete all of the student's assignments before allowing the student to have any leisure-time viewing, since students may become distracted by watching television instead of focusing on an assignment. Thus, if the student does not complete one or more assignments at the time specified by the parent, process 200 may activate a parental lock to prevent the student from watching television. In one embodiment, for example, a control command may be sent from the learning application to the STB/TV 106 viewing application (e.g., IPG, EPG, VOD, PVR applications, etc.). The control command may include instructions for blocking or unblocking television viewing functions according to preset parameters. Using such a “learning lock” enables parents to have greater control over students completing their assignments in a timely manner. In some embodiments, this “learning lock” can be overridden by a parent inputting a personal identification number (PIN) or other such identifier.

Process 200 may then allow students to view the available learning content (task 214) when logged into an SDP account through the STB/TV 106. In one embodiment, a user interface may obtain a list of content when the interactive learning application is started by the STB/TV 106. The list of content can be obtained by the SDP 104 from the LMS 102, stored in a local file repository, and filtered/displayed accordingly. For example, in one embodiment, the content for a particular student's grade level may be retrieved from the set of all content for various grades (e.g., K-12), and then appropriately displayed.

According to some embodiments, the SDP 104 may provide a TV-specific personalized list of content for each student based on account information such as TV-learning subscriptions, etc. Process 200 may display the list of selectable content on the student's STB/TV 106. The list of selectable content generated may be based upon one or more filters. For example, as described below, a student may have subscribed to learning applications A, B and C, but not to learning application D. Thus, the content displayed on the student's STB/TV 106 may correspond only to learning applications A, B, and C.

In some embodiments, process 200 may allow the scheduled content workflow to be displayed (task 216) when the student has logged into an SDP account through the STB/TV 106. The workflow 110 may be obtained by SDP 104 from the LMS 102 (and may be stored in a file repository), and then filtered accordingly. For example, if a subject is not part of a student's TV-learning subscription, then that assignment may not be available for the student, in which case, a service provider can prompt the student to enter into a subscription to that learning application (such as the application D mentioned above). Note that in some embodiments, the TV-specific content workflow can be personalized for each student by SDP 104. Additionally, in some embodiments, a user interface can be provided to display a workflow schedule for the content when the interactive learning application is started by the STB/TV 106.

According to some embodiments, process 200 can automatically setup a workflow 110 for a student on the LMS 102. The workflow generated may be determined by any number of factors, including grade-level, student information, teacher input, recent developments within a particular field, and/or random functions. In some embodiments, process 200 can allow a teacher to create or modify the work flow 110 as explained below.

In one embodiment, for example, if a teacher wishes to make manual modifications to the existing workflow (task 218) schedule (e.g., the tasks are not be challenging enough), the teacher may log into SDP 104 and make changes accordingly. In this example, a teacher may assign additional content to reinforce that day's lesson, provide extra credit work, optional readings, etc. This workflow may also be created by the teacher from scratch on SDP 104 to be LMS 102 workflow independent (i.e., TV-specific workflow for a particular subject). In one embodiment, the teacher can log in to the SDP 104 and browse a listing of choices for a customized workflow, thereby selecting appropriate content from a predetermined list. In other embodiments, the teacher may copy or upload one or more files to the SDP 104. These files may then become the content for a customized workflow, and optionally shared with other teachers with access to the SDP 104. Note that the workflow schedule and homework that is assigned to students may be any combination of required and optional content, as determined by the teacher, as well as any combination of predetermined and/or user-uploaded content.

Process 200 may allow content selection information to be provided to the SDP 104 from the STB/TV 106 (task 220). When the content has been selected on the interactive learning application, a user interface on the STB/TV 106 may send file request information to SDP 104.

Process 200 may then retrieve the file for the student's selection (task 222) by the SDP 104. In some embodiments, the selected file can be streamed in real time from the LMS 102. In some embodiments, the selected file can be obtained from a pre-populated file repository on SDP 104. Note that a variety of file formats may be used for these purposes, including, without limitation, Shockwave Flash files (SWF), hypertext markup language files (HTML), graphic interchange format (GIF), joint photographic expert group files (JPG), Powerpoint files (PPT), portable document format files (PDF), Microsoft Word Documents (DOC), and moving pictures expert group files (MP3, MP4).

Process 200 may then proceed by applying TV-related business logic (task 224) (i.e., functions related to billing, subscriptions, etc). For example, if a student is not eligible to receive certain content, then SDP 104 may filter out such content accordingly.

In some embodiments, process 200 may determine if the content files stored on the LMS 102 contain functionality that is not supported by the STB/TV 106 (task 226). This may result in a limitation that prevents the student from accessing the file or completing the assignment. For example, a file that contains a drag and-drop interaction may not be possible using the student's remote input device, if such a device is not a mouse or a trackball. In such a case, the SDP 104 may first determine if the requested files are useable by the student. This may be determined, for example, by checking a data file indicating the student's hardware setup at a particular MAC address. If more than one version of a file exists, the SDP 104 may then determine if a version exists that is usable by the student. Optionally, unusable files may be dropped from a downloadable package with one or more error messages displayed to the user. In some embodiments, any unusable file and/or workflow may be identified and reported using the SDP 104 reporting module 120.

The content available to each student on the LMS 102 may be provided, for example, on electronic files (e-learning files) that may comprise any number of files and/or file formats. Each file format may have its own particular playback requirements which may or may not be supported by the STB/TV 106. For example, the STB/TV 106 may not have all of the capabilities of a Personal Computer (PC). Hence, in some embodiments, after process 200 determines the file format playback requirements (task 228), the files (e.g., e-learning files) may be modified and/or transcoded into a playback format that is supported by the student's STB/TV 106.

Process 200 may then allow students to interact with the content that is presented on the STB/TV 106 (task 230) using their remote input device for an interactive learning experience. In some embodiments, when the student has completed an assignment, a pop-up/notification may appear on another TV or device that informs a parent of the student's accomplishment. For example, parents may be informed of the student's completion of the assignment by a text message, e-mail, pop-up window, alarm, or other communication. As mentioned above, the SDP personalization may be implemented using the viewer management module 122 in conjunction with the SDP's TV notification and broadcast technology of the playout module 118.

Upon receiving a pop-up/notification, parents can enhance their student's interactive learning experience by selecting or providing additional content for the student (task 232). For example, in one embodiment, when a student has completed an assignment, content related to that subject may become available and/or further subscriptions. Additionally, one or more messages (including text, graphical images, video, audio, etc.) created or selected by the parent may be sent to the student upon completion of the assignment.

In some embodiments, a student's progress with an assignment may be reported (task 234) to the SDP 104 using reporting module 120. For example, when a student performs some event (e.g., pauses during an assignment, completes the assignment, etc.) the SDP 104 may report this activity to the LMS 102. In some embodiments, a listing of such events may be written to one or more event logs.

Process 200 may then apply TV-related business logic that relates to completing an assignment (task 236). For example, if the feature to prevent students from watching television was activated, then that feature may subsequently become deactivated upon the student's completion of the assignment.

In some embodiments, parents may access and set optional features provided by the SDP 104 to help enhance their student's learning experience (task 238). For example, optional content may be scheduled independent of workflow 110 of the LMS 102. This optional content can be scheduled when it is convenient for the parent, for example, at recurring times each day during the week, or as a one-day review session on the weekend.

In some embodiments, students may make changes to their LMS personalized accounts at home (task 240). Students may update their LMS accounts at a local STB/TV 106 using their remote input device. Such updates may then be transmitted to the SDP 104 and/or LMS 102. In some embodiments, a student may be able to change his LMS personalized account from a remote site as well (for example, a STB/TV located outside of the home with an active connection to the LMS 102 via the Internet 130).

In some embodiments, learning content can be copied or downloaded by a user (e.g., students or parents) onto a computer readable medium such as a portable media device 128 from a Kiosk 126 that is connected (via Internet 130, or locally) to the SDP 104. The learning content may then be copied or uploaded onto the STB/TV 106 for presentation on the television STB/TV 106 as explained in more detail below. In this manner, the viewer (e.g., student, parent) can interact with the learning application and/or its contents via an input device coupled to the STB/TV 106 such as a remote control, a keyboard, mouse, touch sensor panel, microphone, etc.

FIG. 3 is an exemplary flowchart showing a method for using a portable media device for distribution by students according to one embodiment of the present invention. The various tasks performed in connection with this process may be performed by software, hardware, firmware, a computer-readable medium having computer executable instructions for performing the process method, or any combination thereof. It should be appreciated that process 300 may include any number of additional or alternative tasks. Also, the tasks shown in FIG. 3 need not be performed in the illustrated order. Additionally, these processes may be incorporated into a more comprehensive procedure or process having additional functionality not described in detail herein. For illustrative purposes, the following description of process 300 may refer to elements mentioned above in connection with FIG. 1. In various embodiments, portions of process 300 may be performed by different elements shown in interaction 100 e.g., LMS 102, SDP 104, Kiosk 126, portable media device 128, and STB/TV 106.

Process 300 may begin by allowing students access to their SDP accounts through Kiosk 106 via Internet 130 (task 302). Kiosks can be located in any number of areas, for example, in common areas within a school such as a cafeteria, classrooms, libraries, etc. Additional access to the SDP 104 may be made available outside of the school, as well as outside of the home, through Kiosks placed in areas such as shopping malls, public libraries, government buildings, etc.

In this manner, process 300 may allow students to log in to their SDP account through the Kiosk 126 (task 304). A portable media device 128 (e.g., USB storage device, flash memory device, etc.) may be connected by the students to the Kiosk 106 for storing a new content and workflow. The portable media device 128 may interface with the Kiosk in a wide variety of ways, for example, by a set of plugs, pins, or other connectors, by a cable (e.g., a high-speed serial bus cable such as a USB or FireWire cable), or by one or more wireless connections.

Process 300 may then obtain the workflow from the SDP 104 via the Kiosk 126. The workflow may have been selected, created, modified, retrieved and/or displayed, for example, as stated above in the context of discussion of FIG. 2 (i.e., tasks 216-218 FIG. 2). Process 300 may then update the workflow data (task 308) on the student's portable media device 128 via the Kiosk 126.

Process 300 may also retrieve the learning content that is associated with the workflow data (task 310). In this manner, the learning content may be streamed by the SDP 104 from the LMS 102 in real time, retrieved asynchronously via one or more network connections, or loaded directly from a local file repository. According to some embodiments, storing the learning content in a remote location may have security advantages over retrieving the content from the local file repository of the Kiosk 126 in that the learning contents are not required to be stored within every Kiosk. Process 300 may then copy or download (task 312) the content that has been retrieved by SDP 104 to the Kiosk 126.

Next, process 300 may copy or download the content to the portable media device 128 (task 314). In this manner, the Kiosk 126 may continually provide the student with new content for interactive learning. With the new content and workflow data stored, the portable media device 128 may be disconnected from the Kiosk 126 by the student.

As such, process 300 may provide the students with a portable means to continue with their interactive learning (task 316). For example, a student can connect the portable media device 128 to the STB/TV 106 or to a PC. Each student can take the current workflow data and learning content to different locations for access.

Optionally, process 300 may allow the student to suspend work on an assignment at a first location and resume his/her interactive learning at another location (e.g., home) (task 318). In some embodiments, a remote input device capable of communication with a first STB/TV 106 may be used by the student to open the interactive learning application at a STB/TV 106 in a second location. The remote input device may contain its own memory source for storing the suspended assignment. In other embodiments, a second remote input device may be used to interface with the STB/TV in the second location, with the suspended assignment being downloadable from a remote server.

In some embodiments, process 300 may provide the new content from the portable media device 128 to the STB/TV 106 (task 320). For example, the portable media device 128 may connect to STB/TV 106 to provide the new workflow data and the content to the STB/TV 106. In one embodiment, the content and new workflow data on the portable media device 128 may be requested by the learning application as needed.

The student may then continue with his/her schoolwork (task 322). In this manner, the student may use the STB/TV 106 and the portable media device 128 to work on the latest school assignments from his/her teacher.

In some embodiments, as the student works on his/her assignments, his/her progress may be tracked (task 324). For example, in one embodiment, the student's progress with assignments, test results, etc. may be saved locally on the portable media device 128. Upon the student returning to the Kiosk 126 and logging in to the SDP 104, progress data (e.g., test results) may be copied or uploaded. The data on the portable media device 128 may then be uploaded via the Kiosk 126 to the SDP 104 (task 326). Based on the data, appropriate updated workflow information may then be reported by the SDP 104 to the LMS 102.

In some embodiments, process 300 may synchronize personalization changes on the portable media device 128, STB/TV 106, LMS 102, or Kiosk 126 (task 328). In one embodiment, for example, any changes made to the personalization for the student (whether made via the STB/TV 106, portable media device 128, LMS 102 or Kiosk 126) are transferred to each of the other respective devices and subsequently applied.

Optionally, process 300 may enable manual or automatic updates of older versions of the interactive learning application on the portable media device 128 (task 330). In one embodiment, for example, any updates to the application may be automatically downloaded when the portable media device 128 is connected to the STB/TV 106. In other embodiments, updates may be applied manually upon user confirmation.

FIG. 4 is an exemplary flowchart showing a method for using a portable media device for distribution by parents, according to an embodiment of the invention. The various tasks performed in connection with this process may be performed by software, hardware, firmware, a computer-readable medium having computer executable instructions for performing the process method, or any combination thereof. It should be appreciated that process 400 may include any number of additional or alternative tasks. Also, the tasks shown in FIG. 4 need not be performed in the illustrated order. Additionally, these processes may be incorporated into a more comprehensive procedure or process having additional functionality not described in detail herein. For illustrative purposes, the following description of process 400 may refer to elements mentioned above in connection with FIG. 1. In various embodiments, portions of process 400 may be performed by different elements shown in interaction 100 e.g., LMS 102, SDP 104, Kiosk 126, portable media device 128, and STB/TV 106.

As shown by FIG. 4, process 400 may allow parents to access an SDP account through a Kiosk 106 (or alternatively, a PC located at, for example, the home or workplace) (task 402). A parent can insert a portable media device 128 into the Kiosk 126 or respective PC and then log into an account associated with a student. In some embodiments, the account may be their child's own account. In other embodiments, parents may utilize one or more separate accounts. In still other embodiments, a single family account may be used by both the parents and their children.

According to some embodiments, process 400 may provide the child's information available by the SDP 104 (task 404). The workflow data and the learning content may be copied or downloaded to the portable media device 128. If more than one child is registered to the parent to use the interactive learning application, then multiple entries corresponding to each child's information may be stored within the portable media device 128.

Process 400 may then allow the parent to store the content and the workflow data on the portable media device 128 (task 406). If a parent chooses to access the SDP account at their workplace, then the content and workflow data may be subsequently transferred to the parent's portable media device 128. Note that in some workplaces, where access to non-volatile storage is restricted, content and workflow data may be directly transferred from volatile memory of the workplace PC to the portable media device 128. Parents may then provide their children with the updated portable media device 128 (task 408), and the interactive learning experience may then commence at task 216 in FIG. 2.

In some embodiments, process 300 may allow parents to receive notifications from SDP 104 on how the child is doing (task 410). Notifications about the student's progress may be provided by the SDP 104 using text messages, e-mail, or other means. Other notifications may include reminders about downloading new content, workflows, and the like. For example, a parent may get an e-mail about the student's next assignment a few days before it is due.

In this manner, various embodiments of the invention provide interactive learning available on TV. Many students around the world can benefit from these embodiments, especially students in countries where access to alternative tools (e.g., PCs) may be difficult to obtain. Additionally, various embodiments of the invention enable parents and teachers to control and monitor a student's performance at anytime in order to ensure appropriate progress is made by the student.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. A device for providing interactive learning on a television, the device comprising:
a communication module adapted to receive educational content from one or more remote devices;
a playout module connected to the communication module and adapted to transmit the educational content to be displayed on a television; and
a receiver module connected to the communication module and adapted to receive input from an input device, wherein the input comprises a set of one or more responses to the educational content.

2. The device of claim 1, wherein the one or more remote devices comprise a remote server.

3. The device of claim 1, wherein the one or more remote devices comprise a set-top box.

4. The device of claim 1, wherein the one or more remote devices comprise the television.

5. The device of claim 1, wherein the one or more remote devices comprise a portable media device.

6. The device of claim 1, further comprising an evaluation module connected to the communication module and adapted to generate a score based on comparing the set of one or more responses to an answer key.

7. The device of claim 6, further comprising a reporting module connected to the communication module and adapted to report the score to a remote device.

8. The device of claim 1, wherein the communications module is further adapted to transmit the set of one or more responses to a remote device.

9. The device of claim 1, further comprising an access module connected to the communication module, wherein the access module is adapted to regulate access to one or more functions of the television based upon a set of conditions.

10. The device of claim 9, wherein the set of conditions comprises receiving the set of one or more responses at the receiver module.

11. The device of claim 10, wherein the set of conditions comprises receiving a predetermined score, wherein the score is determined from the set of one or more responses.

12. A learning management system for providing educational content for use with one or more televisions, the learning management system comprising:
a memory unit adapted to store a set of one or more educational programs, wherein the set of one or more educational programs are adapted for presentation upon a television;
a user identification module connected to the memory unit and adapted to authenticate one or more users;
a workflow module connected to the memory unit and adapted to receive one or more workflows, wherein each workflow is adapted to reference one or more educational programs from the set of one or more educational programs; and
a communication module connected to the memory unit and adapted to transmit a workflow associated with a user to a remote device.

13. The learning management system of claim 12 further comprising a personalization module connected to the communication module and adapted to store personalization settings associated with the one or more users.

14. The learning management system of claim 13, wherein the communication module is further adapted to transmit to a remote device a personalization setting associated with a user after the user has been authenticated at the user authentication module.

15. The learning management system of claim 14, wherein the personalization setting is mapped to a MAC address associated with the user.

16. The learning management system of claim 12, wherein the communication module is further adapted to transmit one or more educational programs associated with the workflow to the remote device.

17. The learning management system of claim 12 wherein the workflow module is further is adapted to transmit a workflow interface to a remote device associated with a user, and wherein the workflow module is further adapted to receive from the remote device associated with the user a set of commands associated with modifying the workflow.

18. The learning management system of claim 12 wherein the workflow module is further is adapted to transmit a workflow interface to a remote device associated with a user, and wherein the workflow module is further adapted to receive from the remote device associated with the user a set of commands associated with creating a new workflow.

19. The learning management system of claim 12, wherein the memory unit is further adapted to receive customized content from a remote device associated with a user, wherein the customized content may be referenced by the one or more workflows.

20. The learning management system of claim 12, wherein the remote device comprises a portable media device.

21. The learning management system of claim 12, wherein the remote device comprises a device adapted to present the one or more educational programs on a television.

22. A method of providing interactive learning on a television using a learning device, the method comprising:
receiving at the learning device a workflow associated with a user;
receiving at the learning device educational content associated with the workflow;
generating a presentation of the educational content on a television connected to the learning device; and
receiving at the learning device a set of one or more inputs from the user in response to the presentation.

23. The method of claim 22, wherein the method further comprises evaluating the set of one or inputs from the user at the learning device.

24. The method of claim 22, wherein the method further comprises generating a control command from the learning device in response to the set of one or more inputs, wherein the control command is adapted to regulate one or more functions of the television.

25. The method of claim 22, further comprising transmitting the set of one or more inputs from the learning device to a remote server.

26. The method of claim 22, further comprising transmitting a status message to a remote device based upon receipt of the set of one or more inputs at the learning device.
